(19) United States
(12) Patent Application Publication
(10) Pub. No.: US 2026/0260403 A1
(43) Pub. Date: Sep. 3, 2026

(54) DATA AUGMENTATION DEVICE, DATA AUGMENTATION METHOD, AND PROGRAM

(71) Applicant: NEC Corporation, Tokyo (JP)

(72) Inventor: Kosuke MORIWAKI, Tokyo (JP)

(73) Assignee: NEC Corporation, Tokyo (JP)

(21) Appl. No.: 19/156,000

(22) PCT Filed: Dec. 12, 2023
(86) PCT No.: PCT/JP2023/044425

§ 371 Date: Aug. 13, 2025

(30) Foreign Application Priority Data
Feb. 21, 2023 (JP) 2023-024891

(51) Int. Cl. G06T 11/60; G06T 7/246; G06V 10/74

(52) U.S. Cl. CPC G06T 11/60; G06T 7/248; G06V 10/761

(57) ABSTRACT

This data augmentation device acquires video data including a plurality of frame sequences, and executes, on the video data, either a deletion process to delete a frame sequence or a position changing process to change a position of a frame sequence. The data augmentation device selects, from among a plurality of editing processes, an editing process to be executed on an editing target that is a connection portion between a first target frame sequence and a second target frame sequence that have become adjacent due to the deleting process or the position changing process, or that is a portion before or after the connection portion. The data augmentation device generates augmented video data by applying the selected editing process the video data.

### TECHNICAL FIELD

The present disclosure relates to data augmentation of a frame sequence.

### BACKGROUND ART

A system that generates new data by subjecting data to processing, that is, performs data augmentation has been developed. For example, NPL 1 discloses a technology of increasing the number of pieces of training data by performing data augmentation on video data prepared as training data in order to train an identification model that performs class identification of input video data.

### CITATION LIST

### Non Patent Literature

NPL 1: Taeoh Kim, Hyeongmin Lee, MyeongAh Cho, Ho Seong Lee, Dong Heon Cho, and Sangyoun Lee, “Learning Temporally Invariant and Localizable Features via Data Augmentation for Video Recognition”, [online], Aug. 13, 2020, arXiv. org, [retrieved on Jan. 13, 2022], Internet, <URL: https://arxiv. org/pdf/2008.05721.pdf>

### SUMMARY OF INVENTION

### Technical Problem

In NPL 1, it is assumed that class identification is performed on the entire video data input to the model (in other words, one class is allocated to the entire video data input to the model). The present disclosure has been made in view of this problem, and an object of the present disclosure is to provide a new technology for performing data augmentation on a frame sequence.

### Solution to Problem

A data augmentation device according to the present disclosure includes an acquisition means for acquiring video data including a plurality of frame sequences each of which includes a plurality of consecutive video frames belonging to a same class, the frame sequences adjacent to each other belonging to different classes from each other; a processing process means for executing a deleting process of deleting one or more of the frame sequences, a position changing process of changing a position of one or more of the frame sequences, or both of the deleting process and the position changing process on the video data; a selection means for selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and a generation means for generating augmented video data by applying the selected editing process to the video data.

A data augmentation method of the present disclosure is executed by a computer. The method includes an acquisition step of acquiring video data including a plurality of frame sequences each of which includes a plurality of consecutive video frames belonging to a same class, the frame sequences adjacent to each other belonging to different classes from each other; a processing process step of executing a deleting process of deleting one or more of the frame sequences, a position changing process of changing a position of one or more of the frame sequences, or both of the deleting process and the position changing process on the video data; a selection step of selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and a generation step of generating augmented video data by applying the selected editing process to the video data.

A program according to the present disclosure causes a computer to execute the data augmentation method of the present disclosure.

### Advantageous Effects of Invention

According to the present disclosure, a new technology for performing data augmentation of a frame sequence is provided.

### BRIEF DESCRIPTION OF DRAWINGS

FIG. 1 is a diagram illustrating video data handled by a data augmentation device.

FIG. 2 is a diagram illustrating an outline of an operation of the data augmentation device.

FIG. 3 is a block diagram illustrating a functional configuration of the data augmentation device.

FIG. 4 is a block diagram illustrating a hardware configuration of a computer that implements the data augmentation device.

FIG. 5 is a flowchart illustrating a flow of a process executed by the data augmentation device.

FIG. 6 is a diagram illustrating class information in a table format.

FIG. 7 is a diagram illustrating a deleting process.

FIG. 8 is a diagram illustrating a moving process.

FIG. 9 is a diagram illustrating a switching process.

FIG. 10 is a diagram illustrating a blending process in which a blending ratio changes with a position.

FIG. 11 is a first diagram illustrating a case of calculating an appropriacy score, based on a motion feature.

FIG. 12 is a second diagram illustrating a case of calculating an appropriacy score, based on a motion feature.

FIG. 13 is a diagram illustrating a method for calculating the appropriacy score in a case where no editing process is performed.

### EXAMPLE EMBODIMENT

Hereinafter, example embodiments of the present disclosure will be described in detail with reference to the drawings. In the drawings, the same or relating elements are given the same reference signs, and repeated description will be omitted as necessary for clarity of description. Unless otherwise described, predefined values such as predetermined values and thresholds are stored in advance in a storage device or the like accessible from a device that uses the predefined values. Furthermore, unless otherwise described, a storage unit includes one or any larger number of storage devices.

### First Example Embodiment

### Overview

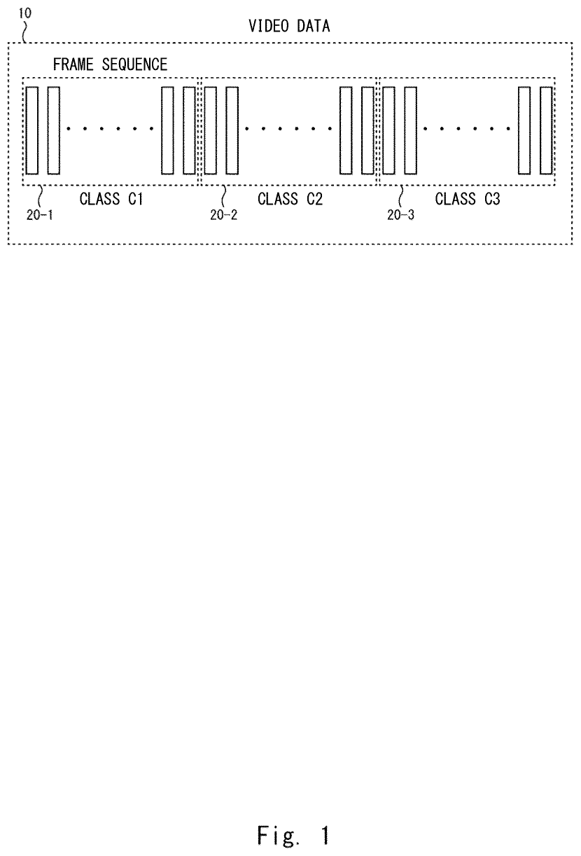

FIG. 1 is a diagram illustrating video data 10 handled by a data augmentation device. The video data 10 is made up of a plurality of time-series video frames 12. In another expression, the video data 10 is a frame sequence in which a plurality of video frames is placed in chronological order (in ascending order of frame numbers).

Each video frame 12 belongs to one of a plurality of classes. The video data 10 includes a plurality of frame sequences 20. The frame sequence 20 is a frame sequence made up of a plurality of consecutive video frames 12 belonging to classes that are the same as each other. For example, the video data 10 in FIG. 1 includes a frame sequence 20-1 made up of a plurality of video frames 12 belonging to a class C1, a frame sequence 20-2 made up of a plurality of video frames 12 belonging to a class C2, and a frame sequence 20-3 made up of a plurality of video frames 12 belonging to a class C3 in this order. Hereinafter, a frame sequence made up of a plurality of video frames 12 belonging to a class C will be also referred to as a “frame sequence belonging to the class C”.

Here, the video data 10 includes at least two frame sequences 20 belonging to classes different from each other. The video data 10 may further include two or more frame sequences 20 belonging to classes that are the same as each other. For example, as in the example in FIG. 1, in a case where the video data 10 includes three frame sequences 20 of the frame sequence 20-1 to the frame sequence 20-3, the frame sequences 20-1 and 20-3 may belong to the class C1, and the frame sequence 20-2 may belong to the class C2.

The class represents, for example, content of the frame sequence 20 (for example, a scene or a situation represented by the frame sequence 20). For example, it is supposed that a state in which a worker is performing work including three processes P1, P2, and P3 is imaged by a video camera, and video data obtained through the imaging is handled as the video data 10. In this case, each work process can be handled as a class. That is, the video data 10 can be divided into three frame sequences 20, namely, a frame sequence 20 including the state of work in the process P1, a frame sequence 20 including the state of work in the process P2, and a frame sequence 20 including the state of work in the process P3.

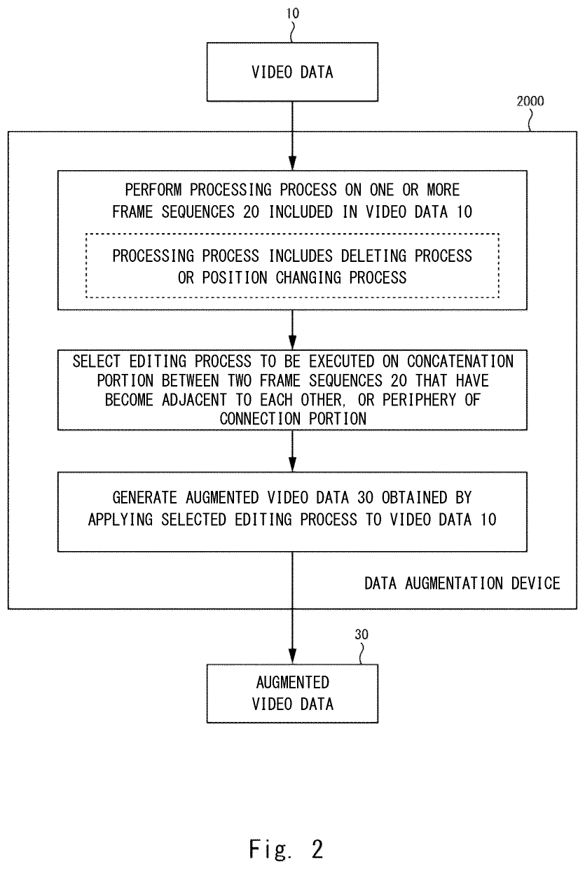

FIG. 2 is a diagram illustrating an outline of an operation of the data augmentation device 2000. Here, FIG. 2 is a diagram for facilitating understanding of the outline of the data augmentation device 2000, and the operation of the data augmentation device 2000 is not limited to that depicted in FIG. 2.

The data augmentation device 2000 processes at least a part of the video data 10 to generate augmented video data 30 different from the video data 10. Consequently, data augmentation is implemented. Processing processes performed on the video data 10 include 1) a deleting process of deleting at least one frame sequence 20 or 2) a position changing process of changing the position of at least one frame sequence 20.

Here, as a result of performing the deleting process or the position changing process (hereinafter, deleting process or the like), two frame sequences 20 that are not adjacent to each other in the original video data 10 may be sometimes made adjacent to each other. For example, it is supposed that the video data 10 includes a frame sequence 20-1, a frame sequence 20-2, and a frame sequence 20-3 in this order. In this case, when the deleting process for deleting the frame sequence 20-2 is performed, the frame sequences 20-1 and 20-3 are made adjacent to each other.

In a case where the frame sequences 20 that are not adjacent to each other in the original video data 10 are made adjacent to each other as a result of the deleting process or the like, it is highly probable that the scene represented by the frame sequences greatly changes before and after a connection portion between the frame sequences 20 that have become adjacent. For example, in a case where the scene represented by the video data 10 is a work by a person, the position and posture of a body part such as a human hand, the position and posture of a tool used for the work, the position and posture of a component to be worked on, or the like may possibly change greatly before and after the connection portion. The connection portion between two frame sequences 20 means a point between these two frame sequences 20.

Accordingly, the data augmentation device 2000 may perform an editing process on the connection portion between two frame sequences 20 made adjacent as a result of the deleting process or the like, or a periphery of the connection portion. Hereinafter, two frame sequences 20 made adjacent as a result of the deleting process or the like will also be expressed as “editing targets”. Among the two frame sequences 20 included in the editing targets, the frame sequence 20 positioned earlier will also be expressed as a “first target frame sequence”, and the frame sequence 20 positioned later will also be expressed as a “second target frame sequence”.

There is a plurality of types of processes for the editing processes that can be executed on the editing target by the data augmentation device 2000. For example, the editing process is a process of blending an end portion of the first target frame sequence and a start portion of the second target frame sequence on each other at a predetermined ratio (hereinafter, a blending process). The end portion of the first target frame sequence and the start portion of the second target frame sequence are frame sequences made up of the same number (one or more) of frames.

Another example of the editing process is an interpolation process of inserting one or more new frames between the first target frame sequence and the second target frame sequence. For example, the interpolation process can be implemented using a trained machine learning model (hereinafter, an interpolation model).

The data augmentation device 2000 selects an editing process to be performed on the editing target from among a plurality of types of editing processes. Then, the data augmentation device 2000 generates, as the augmented video data 30, video data in which the editing target included in the video data 10 has been subjected to the selected editing process.

Here, the data augmentation device 2000 may select two or more editing processes. For example, it is supposed that the data augmentation device 2000 selects two editing processes of an editing process E1 and an editing process E2. In this case, the data augmentation device 2000 can generate two pieces of augmented video data 30, namely, the augmented video data 30 in which the editing target has been subjected to the editing process E1 and the augmented video data 30 in which the editing target has been subjected to the editing process E2.

### Example of Action and Effect

According to the data augmentation device 2000, the augmented video data 30 is generated by performing a processing process on one or more frame sequences 20 included in the video data 10. Here, the video data 10 includes a plurality of frame sequences 20 belonging to different classes from each other. Therefore, according to the data augmentation device 2000, a frame sequence including a plurality of frame sequences 20 belonging to different classes from each other can be generated by data augmentation.

Such data augmentation is useful, for example, for training an identifier that identifies a class of each video frame constituting a frame sequence in response to input of the frame sequence. For example, an identifier that identifies a class of each video frame in response to input of video data, or the like is conceivable. The training data used for training such an identifier indicates, for example, a frame sequence as input data and indicates a class of each video frame included in the frame sequence as ground-truth data.

In order to obtain an identifier having high identification accuracy, it is preferable to train the identifier using a large amount of training data. However, it takes time and effort to prepare a large amount of training data. In this regard, if the data augmentation device 2000 is used, the amount of training data can be increased by data augmentation. Therefore, time and effort taken to prepare the training data can be reduced, and a large amount of training data can be more easily prepared.

In order to obtain an identifier having high accuracy, it is suitable to expand the number of variations of the training data. However, when the training data is generated, there is a case where a bias is likely to arise in such variations. For example, as such a case, there is a case where training data is prepared by observing a real situation. A more specific example is a case where video data obtained by imaging a state of daily work in a factory with a monitoring camera is utilized as training data.

In a case where an actual situation is observed in this manner, an anomalous situation is less likely to be observed than a normal situation. For example, in the case of imaging the work in the factory described above, it is considered that the work is performed in a normal procedure in most cases, and the work performed in an incorrect procedure is rarely imaged. Therefore, the number of pieces of training data representing an anomalous situation is smaller than the number of pieces of training data representing a normal situation. However, in order to expand the number of variations of the training data, it is preferable that the number of pieces of training data representing an anomalous situation is also large.

In this regard, when the data augmentation device 2000 is used, the augmented video data 30 representing an anomalous situation can be generated by acquiring a frame sequence representing a normal situation as the video data 10 and performing a processing process on the acquired frame sequence. For example, video data representing a state of anomalous work can be generated from video data in which a state of daily normal work is recorded. Thus, according to the data augmentation device 2000, variations of the training data can be easily increased.

Furthermore, as described earlier, it is highly probable that the scene represented by the frame sequences greatly changes before and after the connection portion between two frame sequences 20 that have become adjacent as a result of the deleting process or the like. Therefore, it is suitable to make the scene represented by the augmented video data 30 closer to the real scene by relaxing a change in the scene before and after the connection portion by applying some editing process to the connection portion or a periphery of the connection portion.

In this regard, the editing process that can be executed on the connection portion between two frame sequences 20 can include a plurality of options such as the blending process and the interpolation process described above. As will be described later, there can be a plurality of options also for a ratio of blending in the blending process and an interpolation algorithm used in the interpolation process. Then, what kind of editing process is appropriate depends on the content and the like of the frame sequence 20, and it is thus difficult to assign the best editing process in advance.

Accordingly, the data augmentation device 2000 dynamically selects an editing process to be applied to the editing target from among a plurality of editing processes. With this way of proceeding, the editing target can be subjected to an appropriate editing process. As a result, the scene represented by the augmented video data 30 can be made closer to the real scene. In other words, the unnaturalness can be decreased in the augmented video data 30 generated by data augmentation. By using such augmented video data 30 having smaller unnaturalness, for example, the identification accuracy of the above-described identifier can be further improved.

Hereinafter, the data augmentation device 2000 will be described in more detail.

### Example of Functional Configuration

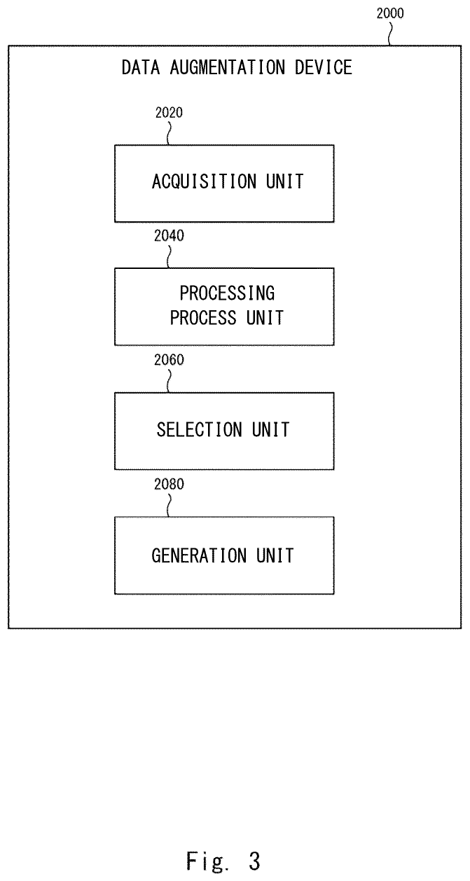

FIG. 3 is a block diagram illustrating a functional configuration of the data augmentation device 2000. The data augmentation device 2000 includes an acquisition unit 2020, a processing process unit 2040, a selection unit 2060, and a generation unit 2080. The acquisition unit 2020 acquires the video data 10. The processing process unit 2040 executes a processing process on one or more frame sequences 20 included in the video data 10. The selection unit 2060 selects an editing process to be executed on the editing target. The generation unit 2080 generates the augmented video data 30 in which the editing target has been subjected to the editing process.

### Example of Hardware Configuration

Each functional constituent of the data augmentation device 2000 may be implemented by hardware (for example, a hard-wired electronic circuit) that implements each functional constituent, or may be implemented by a combination of hardware and software (for example, a combination of an electronic circuit and a program that controls the electronic circuit). Hereinafter, a case where each functional constituent of the data augmentation device 2000 is implemented by a combination of hardware and software will be further described.

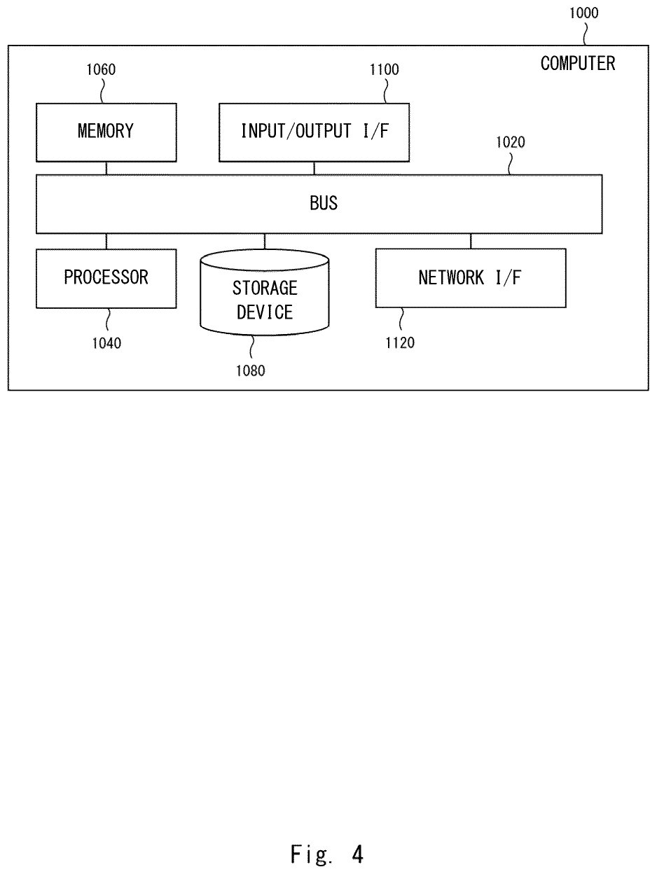

FIG. 4 is a block diagram illustrating a hardware configuration of a computer 1000 that implements the data augmentation device 2000. The computer 1000 is any computer. For example, the computer 1000 is a stationary computer such as a personal computer (PC) or a server machine. In another example, the computer 1000 is a portable computer such as a smartphone or a tablet terminal. The computer 1000 may be a dedicated computer designed to implement the data augmentation device 2000, or may be a general-purpose computer.

For example, by installing a predetermined application in the computer 1000, each function of the data augmentation device 2000 is implemented in the computer 1000. The above-mentioned application is constituted with a program for implementing each functional constituent of the data augmentation device 2000. Any method for acquiring the above program can be employed. For example, the program can be acquired from a storage medium (a digital versatile disc (DVD) disk, a universal serial bus (USB) memory, or the like) in which the program is stored. In another example, the program can also be acquired by downloading the program from a server device that manages the storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method for connecting the processor 1040 and the like to each other is not limited to the bus connection.

The processor 1040 is any of various types of processors such as a central processing unit (CPU), a graphics processing unit (GPU), or a field-programmable gate array (FPGA). The memory 1060 is a primary storage device implemented using a random access memory (RAM) or the like. The storage device 1080 is an auxiliary storage device implemented using a hard disk, a solid state drive (SSD), a memory card, a read only memory (ROM), or the like.

The input/output interface 1100 is an interface for connecting the computer 1000 with an input/output device. For example, an input device such as a keyboard and an output device such as a display device are connected to the input/output interface 1100.

The network interface 1120 is an interface for connecting the computer 1000 to a network. The network may be a local area network (LAN) or a wide area network (WAN).

The storage device 1080 stores a program for implementing each functional constituent of the data augmentation device 2000 (a program for implementing the above-described application). The processor 1040 reads the program into the memory 1060 and executes the read program to implement each functional constituent of the data augmentation device 2000.

The data augmentation device 2000 may be implemented by a single computer 1000 or may be implemented by a plurality of computers 1000. In the latter case, the configurations of the computers 1000 do not need to be the same and can be different from each other.

### Flow of Process

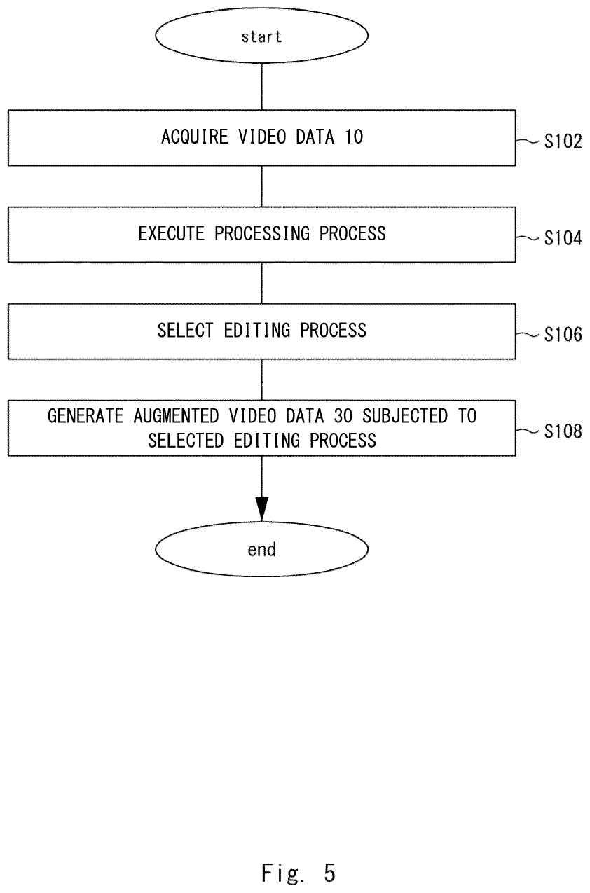

FIG. 5 is a flowchart illustrating a flow of a process executed by the data augmentation device 2000. The acquisition unit 2020 acquires the video data 10 (S102). The processing process unit 2040 executes a processing process on the video data 10 (S104). The selection unit 2060 selects an editing process to be performed on the editing target (S106). The generation unit 2080 generates the augmented video data 30, based on the selection result (S108).

### Acquisition of Video Data 10: S1022

The acquisition unit 2020 acquires the video data 10. Here, various methods can be adopted as a method for acquiring a frame sequence that is a processing target. For example, it is supposed that the video data 10 is stored in advance in any storage device in a form acquirable from the data augmentation device 2000. In this case, the acquisition unit 2020 acquires the video data 10 by reading the video data 10 from this storage device.

In another example, the acquisition unit 2020 acquires the video data 10 by receiving the video data 10 transmitted from another device. The device that transmits the video data 10 is, for example, a device that has generated the video data 10. In a case where the video data 10 is video data, for example, the acquisition unit 2020 acquires the video data 10 from a video camera that has generated the video data 10.

### Information for Specifying Class of Video Frame 12

The data augmentation device 2000 needs to be able to specify classes to which each frame sequence 20 belongs. Accordingly, for example, the data augmentation device 2000 acquires information indicating classes to which each frame sequence 20 belongs (hereinafter, class information).

For example, the class information indicates, for each video frame 12, an association between identification information (for example, a frame number) on the video frame 12 included in the video data 10 and identification information on a class to which that video frame 12 belongs. In another example, the class information may indicate identification information on one or both of the start video frame 12 and the end video frame 12 for each frame sequence 20 included in the video data 10.

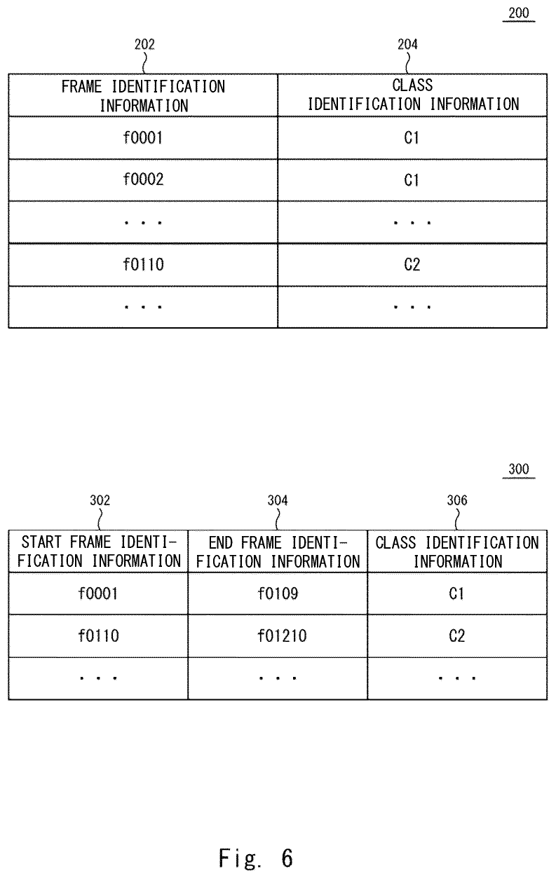

FIG. 6 is a diagram illustrating the class information in a table format. A table 200 indicates classes to which each video frame 12 belongs, for each video frame 12. More specifically, identification information (class identification information 204) on the class to which the video frame 12 belongs is indicated in association with identification information (frame identification information 202) on that video frame 12.

Meanwhile, a table 300 indicates classes to which each frame sequence 20 belongs, for each frame sequence 20. More specifically, for the frame sequence 20, identification information (class identification information 306) on a class to which the frame sequence 20 belongs is indicated in association with a combination of identification information (start frame identification information 302) on the start video frame 12 and identification information (end frame identification information 304) on the end video frame 12.

The class information may be information integrated with the video data 10 or may be information separate from the video data 10. In the former case, for example, identification information on a class to which the video frame 12 belongs is added as metadata to each video frame 12 included in the video data 10. In a case where the video data 10 and the class information are configured separately, for example, the acquisition unit 2020 further acquires the class information about the video data 10 in addition to the acquired video data 10. The method for acquiring the class information is similar to the method for acquiring the video data 10.

### Processing Process: S104

The processing process unit 2040 executes one or more processing processes on the video data 10 (S104). As described above, the processing process includes the deleting process or the position changing process. The deleting process is a process of removing the targeted frame sequence 20 from the video data 10.

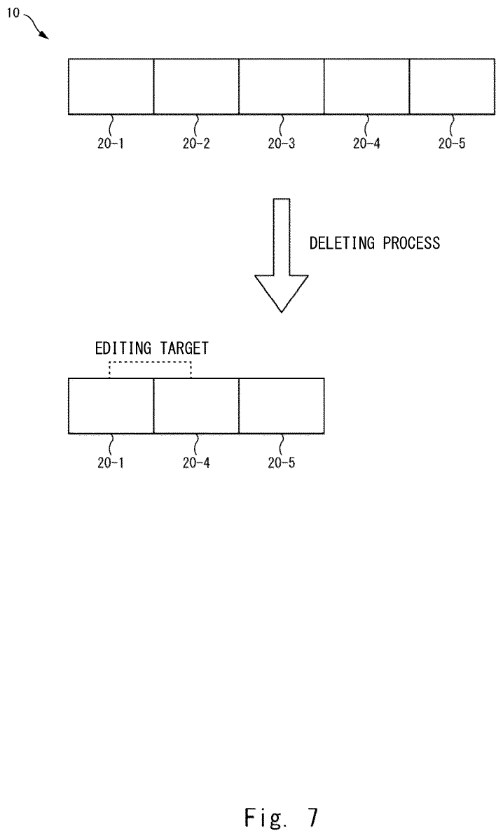

FIG. 7 is a diagram illustrating the deleting process. In FIG. 7, the processing process unit 2040 deletes the frame sequences 20-2 and 20-3 from the video data 10. As a result, the frame sequences 20-1 and 20-4 are made adjacent to each other. Therefore, in this example, a pair of the frame sequences 20-1 and 20-4 is treated as an editing target. The frame sequence 20-1 and the frame sequence 20-4 are treated as the first target frame sequence and the second target frame sequence, respectively.

The position changing process is a process of changing the position of the targeted frame sequence 20. Here, the position changing process includes a moving process of moving one frame sequence 20 to another position, a switching process of interchanging between positions of two frame sequences 20, and the like.

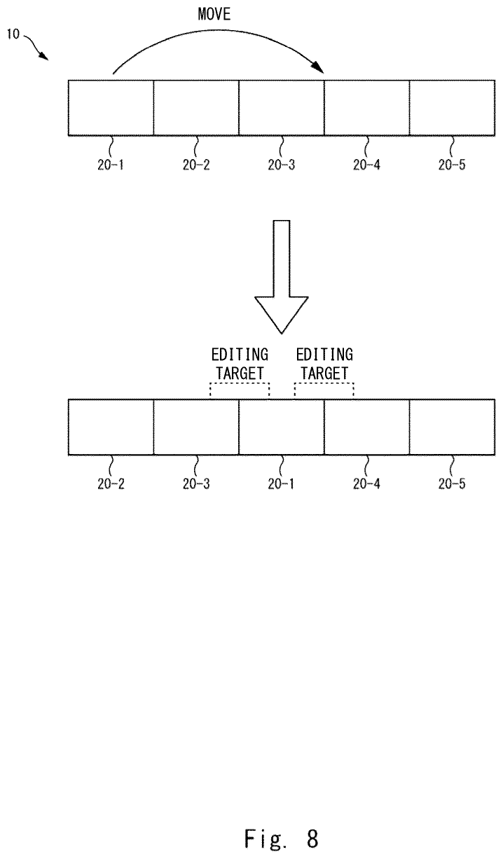

FIG. 8 is a diagram illustrating the moving process. In the example in FIG. 8, the frame sequence 20-1 is moved after the frame sequence 20-3. As a result, the frame sequences 20-3 and 20-1 are made adjacent to each other. The frame sequences 20-1 and 20-4 are also made adjacent to each other.

Consequently, in the example in FIG. 8, there are two editing targets. The first editing target is a pair of the frame sequences 20-3 and 20-1. The second editing target is a pair of the frame sequences 20-1 and 20-4. In the first editing target, the first target frame sequence and the second target frame sequence are the frame sequence 20-3 and the frame sequence 20-1, respectively. In the second editing target, the first target frame sequence and the second target frame sequence are the frame sequence 20-1 and the frame sequence 20-4, respectively.

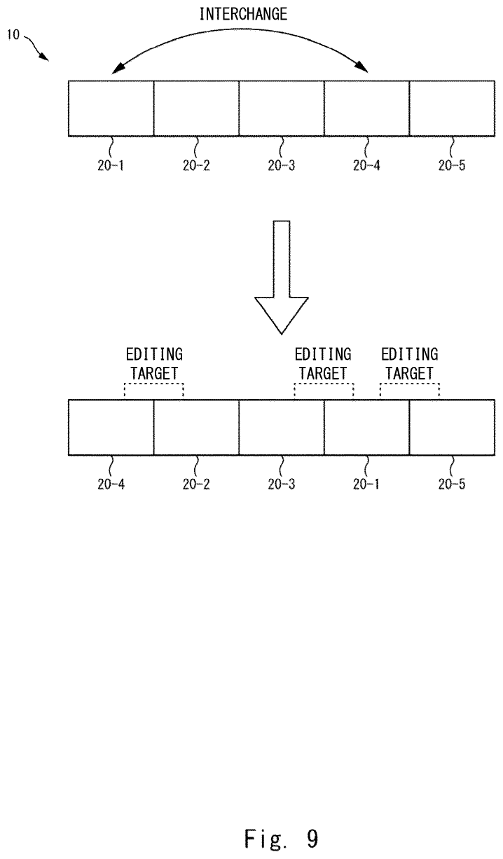

FIG. 9 is a diagram illustrating the switching process. In the example in FIG. 9, the position of the frame sequence 20-1 and the position of the frame sequence 20-4 are interchanged. As a result, the frame sequences 20-4 and 20-2 are made adjacent to each other. The frame sequences 20-3 and 20-1 are also made adjacent to each other. Furthermore, the frame sequences 20-1 and 20-5 are made adjacent to each other.

Consequently, in the example in FIG. 9, there are three editing targets. The first editing target is a pair of the frame sequences 20-4 and 20-2. The second editing target is a pair of the frame sequences 20-3 and 20-1. The third editing target is a pair of the frame sequences 20-1 and 20-5.

In the first editing target, the first target frame sequence and the second target frame sequence are the frame sequence 20-4 and the frame sequence 20-2, respectively. In the second editing target, the first target frame sequence and the second target frame sequence are the frame sequence 20-3 and the frame sequence 20-1, respectively. In the third editing target, the first target frame sequence and the second target frame sequence are the frame sequence 20-1 and the frame sequence 20-5, respectively.

### Selection of Processing Process

The type of processing process to be performed on the video data 10 may be designated in advance or may be freely selected. The number of processing processes performed on the video data 10 may be one or more. The type and the number of processing processes may be randomly selected, or may be selected in accordance with some rule. In a case where a plurality of pieces of augmented video data 30 is to be generated from the video data 10, for example, processing processes are sequentially selected in accordance with a predefined order.

Similarly, the frame sequence 20 targeted for the processing process may also be designated in advance or may be freely selected.

### Example of Editing Process

For example, as described above, the editing process includes the blending process and the interpolation process. Hereinafter, the blending process and the interpolation process will be described in more detail.

### Blending Process

The blending process is a process of blending an end portion of the first target frame sequence with a start portion of the second target frame sequence at a predetermined ratio (hereinafter, a blending ratio). Such a process is also called alpha blending or the like. Here, the process of blending two frame sequences at a predetermined blending ratio is implemented by blending a pair of video frames arranged at a same position on the time axis on each other at the predetermined blending ratio. An existing process can be used for a specific process for generating one video frame by blending two video frames at a predetermined ratio.

A plurality of types of blending processes that can be executed by the selection unit 2060 may be prepared. For example, a plurality of blending processes is defined in such a way that sections to be blended (hereinafter, blending sections) have lengths different from each other. For example, in the blending process of which the blending section is one second, an end frame sequence of one second of the first target frame sequence and a start frame sequence of one second of the second target frame sequence are blended on each other. In another example, a plurality of blending processes is defined in such a way that blending ratios are different from each other. In another example, a plurality of blending processes is defined in such a way that combinations of the blending sections and the blending ratios are different from each other.

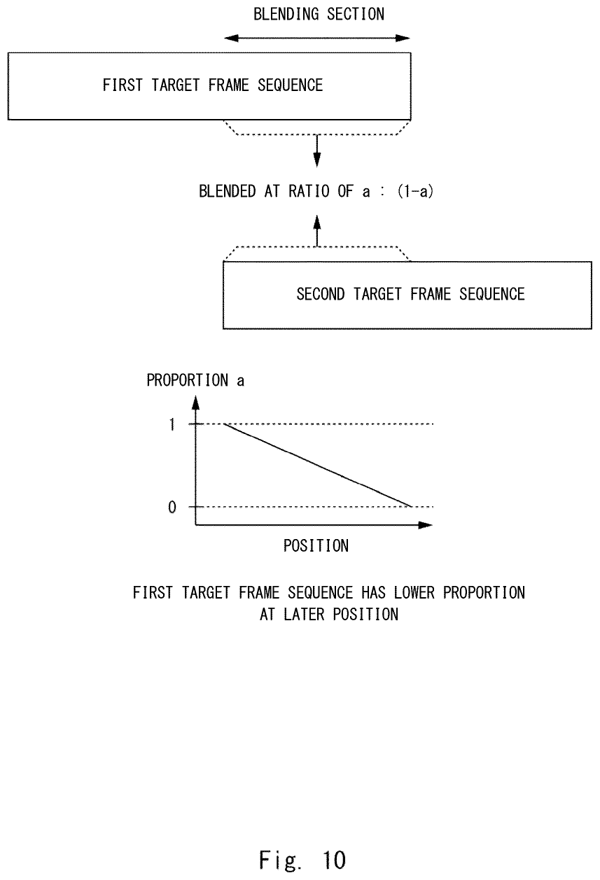

Here, the blending ratio may be fixed regardless of the position or may change with the position. FIG. 10 is a diagram illustrating the blending process in which the blending ratio changes with the position. In the example in FIG. 10, a first target frame sequence 40 and a second target frame sequence 50 are blended at a ratio of a:(1-a).

Here, the value of the proportion a of the first target frame sequence 40 changes in such a way as to become smaller toward a later position. Therefore, in the first half of the blending section, the proportion of the first target frame sequence 40 located earlier becomes greater, while in the second half of the blending section, the proportion of the second target frame sequence 50 located later becomes greater. This corresponds to fading out of the first target frame sequence 40 while the second target frame sequence 50 is fading in.

In the example in FIG. 10, the ratio a becomes smaller in proportion to the position. However, the change in the ratio a does not need to be a change proportional to the position and may be a curved change or the like.

In a case where the blending ratio is changed according to the position in this manner, a plurality of blending processes may be set in such a way that the change in the blending ratio is different from each other.

### Interpolation Process

The interpolation process is a process of inserting one or more new video frames between the first target frame sequence 40 and the second target frame sequence 50. For example, as described above, the interpolation process is performed using an interpolation model.

The interpolation model is configured in such a way as to acquire two frame sequences as inputs and generate a frame sequence to be inserted between the acquired two frame sequences. For example, the interpolation model is trained in advance using training data including a combination of a preceding frame sequence, a following frame sequence, and a frame sequence desired to be inserted between those two frame sequences. Here, as a specific configuration of a machine learning model that performs interpolation by inserting a frame sequence between two frame sequences, various types of existing configurations can be used. As a specific training method for the machine learning model that performs such interpolation, various types of existing training methods can be used.

A plurality of types of interpolation processes that can be executed by the selection unit 2060 may be prepared. For example, a plurality of interpolation processes is defined in such a way that types of machine learning models used as interpolation models are different from each other (in other words, the algorithms of the interpolation processes are different from each other). In another example, a plurality of interpolation processes is defined in such a way as to use interpolation models trained with different pieces of training data from each other. In another example, a plurality of interpolation processes is defined in such a way that the frame sequences generated by the interpolation models have different lengths from each other.

In another example, a plurality of interpolation processes is defined such a way that the lengths of the frame sequences used for interpolation are different from each other. For example, in a case where the length of the frame sequence used for interpolation is 30, the interpolation model acquires a frame sequence made up of 30 video frames from an end portion of the first target frame sequence 40, as a frame sequence of the end portion of the first target frame sequence 40.

Similarly, the interpolation model acquires a frame sequence made up of 30 video frames from a start portion of the second target frame sequence 50, as a frame sequence of the start portion of the second target frame sequence 50.

The length of the end portion of the first target frame sequence 40 and the length of the start portion of the second target frame sequence 50 may be defined in such a way as to be different from each other. For example, it is supposed that the length of the end portion of the first target frame sequence 40 and the length of the start portion of the second target frame sequence 50 are defined as 20 and 30, respectively. In this case, the interpolation model acquires 20 video frames from an end portion of the first target frame sequence 40, as the end portion of the first target frame sequence 40, and acquires 30 video frames of the augmented video data from a start portion of the second target frame sequence 50, as the start portion of the second target frame sequence 50.

### Selection of Editing Process: S106

The selection unit 2060 selects an editing process to be applied to the editing target from among a plurality of editing processes (S106). Hereinafter, a method for selecting an editing process will be illustrated.

For example, the selection unit 2060 applies each of the plurality of editing processes to the editing target and determines an editing process to be selected, based on the results of the application. In this case, the selection unit 2060 calculates an index value representing the degree of appropriateness of the editing target to which an editing process has been applied, for each applied editing process. Hereinafter, this index value will be also expressed as an appropriacy score. The selection unit 2060 selects an editing process, based on the appropriacy score calculated for each editing process.

For example, the selection unit 2060 selects an editing process having the maximum appropriacy score. In another example, the selection unit 2060 selects an editing process having an appropriacy score equal to or more than a predetermined threshold.

Here, sometimes there may be a plurality of editing processes having an appropriacy score equal to or more than the threshold. In this case, the selection unit 2060 may select all of this plurality of editing processes or may select some of the editing processes. In the latter case, for example, the number N (N is equal to or more than one) of selectable editing processes is predefined. The selection unit 2060 selects higher-ranked N editing processes in descending order of the appropriacy score among the editing processes having an appropriacy score equal to or more than the threshold.

As in the examples in FIGS. 8 and 9, sometimes there may be a plurality of editing targets. In this case, the generation unit 2080 selects an editing process for each editing target.

### Method for Calculating Appropriacy Score

For example, the appropriacy score can be represented by a degree of similarity between a feature of a motion of an object in a portion of the editing target that has been subjected to the editing process (hereinafter, an edited portion) and a feature of the motion of the object in a portion of the editing target that has not been subjected to the editing process (hereinafter, a non-edited portion). This is because, as the feature of the motion of the object in the edited portion is more similar to the feature of the motion of the object in the non-edited portion, it can be said that the scenes before and after the edited portion are more naturally connected by the scene of the edited portion. Hereinafter, the index value representing a feature of a motion of an object represented by the frame sequence (in other words, a motion of an object in a scene recorded in the frame sequence) will be denoted as a motion feature.

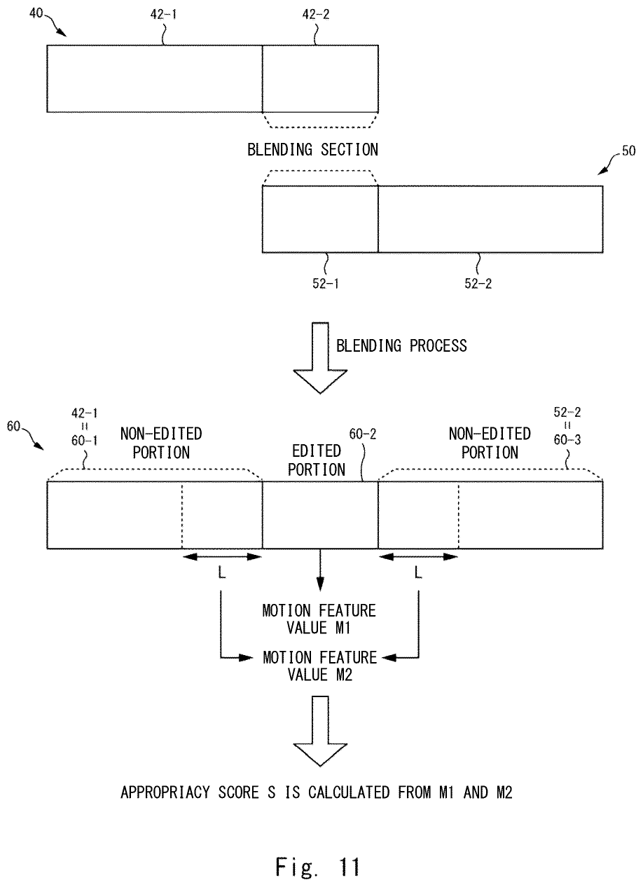

FIG. 11 is a first diagram illustrating a case of calculating the appropriacy score, based on the motion feature value. FIG. 11 illustrates a case where the blending process is performed.

In this example, a frame sequence 60 is generated by applying the blending process to the first target frame sequence 40 and the second target frame sequence 50. Here, in the first target frame sequence 40, the end portion targeted for the blending process is a frame sequence 42-2. In the second target frame sequence 50, the target of the blending process is a frame sequence 52-1.

The frame sequence 60 is made up of 1) a frame sequence 60-1 corresponding to a frame sequence 42-1 that is a non-edited portion in the first target frame sequence 40, 2) a frame sequence 60-2 generated by blending the frame sequences 42-2 and 52-1, and 3) a frame sequence 60-3 corresponding to a frame sequence 52-2 that is a non-edited portion in the second target frame sequence 50.

In a case where the blending process is performed, the edited portion is a frame sequence generated by the blending. In the example in FIG. 11, the edited portion is the frame sequence 60-2. The non-edited portion is a portion other than the edited portion. In the example in FIG. 11, the non-edited portions are the frame sequences 60-1 and 60-3.

The selection unit 2060 calculates a motion feature value MI for the frame sequence 60-2 that is an edited portion. The selection unit 2060 also calculates the motion feature values for each of the frame sequences 60-1 and 60-3 that are non-edited portions and calculates a motion feature value M2 from the calculated two motion feature values.

Here, as will be described in detail later, the motion feature value is represented by a scalar, a distribution, or the like. In a case where the motion feature value is represented by a scalar, for example, the motion feature value M2 is represented by a statistical value (for example, an average value) of the motion feature value calculated for the frame sequence 60-1 and the motion feature value calculated for the frame sequence 60-3. In a case where the motion feature value is represented by a distribution, for example, the motion feature value M2 is represented by a distribution obtained by merging the distribution calculated for the frame sequence 60-1 and the distribution calculated for the frame sequence 60-3.

Here, the motion feature value M2 calculated for the non-edited portion may be calculated using the whole of the non-edited portion or may be calculated using a part of the non-edited portion. FIG. 11 illustrates an example of the latter case. Specifically, the selection unit 2060 calculates the motion feature value M2 from a frame sequence having a length L of each of the end portion of the non-edited portion in first target frame sequence 40 and the start portion of the non-edited portion in the second target frame sequence 50.

The selection unit 2060 calculates an appropriacy score S, based on the motion feature values M1 and M2. For example, in a case where the motion feature value is represented by a scalar, the appropriacy score S is represented by a ratio of the motion feature value MI to the motion feature value M2 (that is, M1/M2). However, as will be described later, the way of representing the motion feature value is not limited to the scalar.

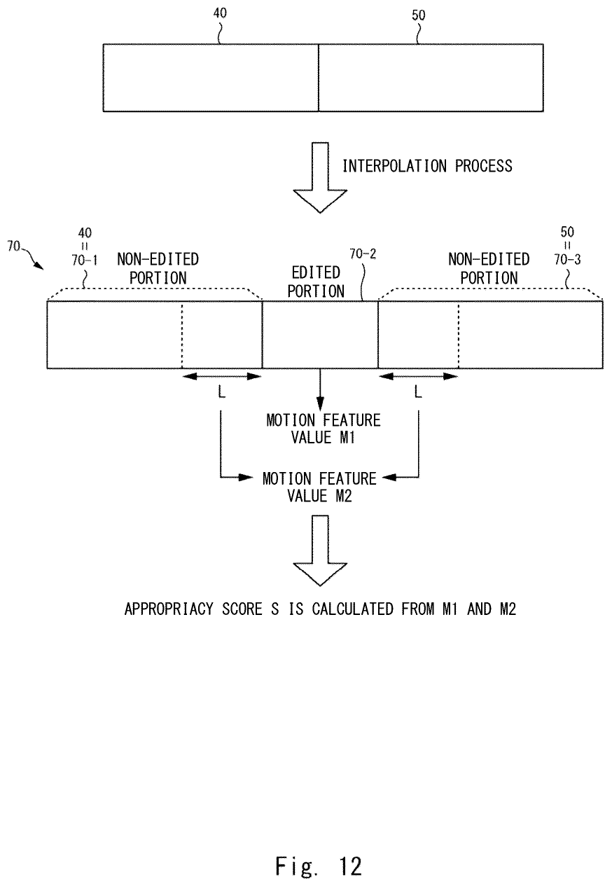

FIG. 12 is a second diagram illustrating a case of calculating the appropriacy score, based on the motion feature value. FIG. 12 illustrates a case where the interpolation process is performed.

In this example, a frame sequence 70 is generated by applying the interpolation process to the first target frame sequence 40 and the second target frame sequence 50. The frame sequence 70 is made up of 1) a frame sequence 70-1 corresponding to the entire first target frame sequence 40, 2) a frame sequence 60-2 that is a frame sequence generated by the interpolation process, and 3) a frame sequence 70-3 corresponding to the entire second target frame sequence 50.

In a case where the interpolation process is performed, the edited portion is a frame sequence generated by the interpolation process. In the example in FIG. 12, the edited portion is the frame sequence 70-2. The non-edited portion is a portion other than the edited portion. In the example in FIG. 12, the non-edited portions are the frame sequences 70-1 and 70-3.

The selection unit 2060 calculates the motion feature value M1 for the frame sequence 70-2 that is an edited portion. The selection unit 2060 also calculates the motion feature values for each of the frame sequences 70-1 and 70-3 that are non-edited portions and calculates the motion feature value M2 from the calculated two motion feature values. Then, the selection unit 2060 calculates the appropriacy score S, based on the motion feature values M1 and M2. The method for calculating the motion feature value M2 from the motion feature values calculated for each of the frame sequences 70-1 and 70-3 is similar to the method for calculating the motion feature value M2 from the motion feature values calculated for each of the frame sequences 60-1 and 60-3. Also in the example in FIG. 12, similarly to the example in FIG. 11, the motion feature value M2 is calculated using a part of the non-edited portion.

### Method for Calculating Motion Feature Value

There are various methods for calculating the motion feature value. For example, the selection unit 2060 calculates a statistical value (for example, an average value) of the magnitude of a motion of an object represented by a frame sequence, as the motion feature value for that frame sequence. Specifically, the selection unit 2060 calculates a value representing the magnitude of a motion of an object for each of possible pairs of two video frames adjacent to each other obtained from a certain frame sequence A. Then, the selection unit 2060 calculates a statistical value of all the calculated values, as the motion feature value of the frame sequence A. Here, as the value representing the magnitude of a motion of an object, the magnitude of the optical flow, a difference value of pixels between video frames, and the like can be used.

In a case where the motion feature value is represented by a statistical value of the magnitude of a motion of an object in this manner, for example, the selection unit 2060 calculates a ratio of the motion feature value M1 calculated for the edited portion to the motion feature value M2 calculated for the non-edited portion, as the appropriacy score S, as described above.

In another example, the motion feature value may be represented by a distribution (for example, a histogram) of values representing the magnitude of a motion of an object. In this case, the selection unit 2060 calculates the degree of similarity between the distribution calculated for the edited portion and the distribution calculated for the non-edited portion, as the appropriacy score. Here, for example, Kullback-Leibler (KL) divergence can be used as a value representing the degree of similarity between the two distributions.

### Case Where No Editing Process is Performed on Editing Target

The selection unit 2060 may generate the augmented video data 30 without performing any editing process on the editing target. For example, the selection unit 2060 also calculates the appropriacy score for a case where no editing process is performed on the editing target. Then, for example, in a case where the appropriacy score of the case where no editing process is performed is more than the appropriacy scores calculated for each editing process, the selection unit 2060 generates the augmented video data 30 without performing any editing process on the editing target.

In another example, the selection unit 2060 verifies whether the appropriacy score of the case where no editing process is performed is equal to or more than a threshold and, in a case where the verified appropriacy score is equal to or more than the threshold, also generates the augmented video data 30 for the case where no editing process is performed. For example, it is supposed that the appropriacy score calculated for an editing process E1 and the appropriacy score calculated for the case where no editing process is performed are equal to or more than the threshold. In this case, the selection unit 2060 generates the augmented video data 30 in which the editing target has been subjected to the editing process E1 and the augmented video data 30 in which the editing target is not subjected to any editing processes.

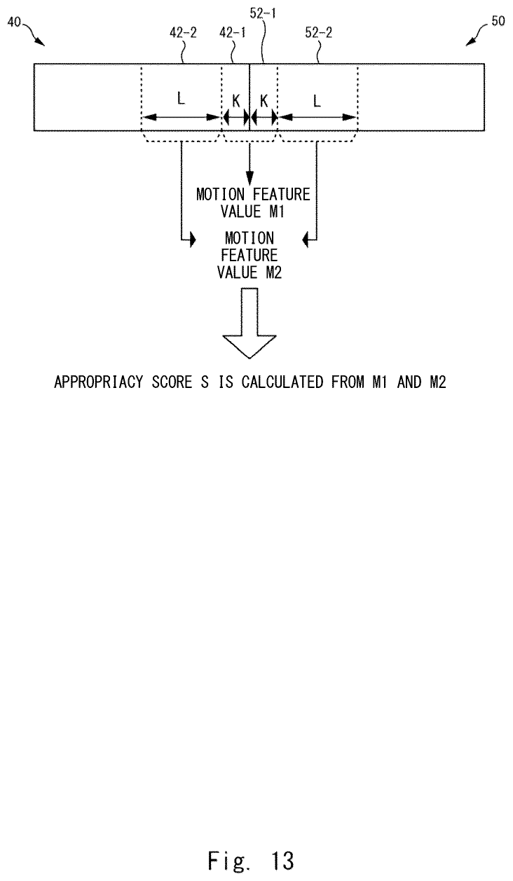

Here, a method for calculating the appropriacy score will be described for a case where no editing process is performed. FIG. 13 is a diagram illustrating a method for calculating the appropriacy score in a case where no editing process is performed. In this example, the selection unit 2060 calculates the motion feature value M1 for a frame sequence made up of a frame sequence 42-1 that is an end portion of the first target frame sequence 40 and a frame sequence 52-1 that is a start portion of the second target frame sequence 50. The frame sequences 42-1 and 52-1 both have a predetermined length K (K is equal to or more than one).

The selection unit 2060 also calculates the motion feature values for a frame sequence 42-2 that is a portion obtained by excluding the frame sequence 42-1 from the end portion of the first target frame sequence 40, and a frame sequence 52-2 that is a portion obtained by excluding the frame sequence 52-1 from the start portion of the second target frame sequence 50. Both the frame sequences 42-2 and 52-2 are frame sequences having a length L (L is equal to or more than one). The selection unit 2060 further calculates the motion feature value M2 from the motion feature value calculated for the frame sequence 42-2 and the motion feature value calculated for the frame sequence 52-2. Then, the selection unit 2060 calculates the appropriacy score, based on the motion feature value M1 and the motion feature value M2.

The method for calculating the motion feature value M2 based on the motion feature value calculated for the frame sequence 42-2 and the motion feature value calculated for the frame sequence 52-2 is similar to the method for calculating the motion feature value M2 based on the motion feature value calculated for the frame sequence 60-1 and the motion feature value calculated for the frame sequence 60-3.

### Generation of Augmented Video Data 30: S108

The generation unit 2080 generates the augmented video data 30 subjected to the selected editing process (S108). Here, in order to calculate the appropriacy score described above, the generation unit 2080 has already generated frame sequences obtained by applying a plurality of types of editing processes to the editing target, for each of the plurality of types of editing processes. Therefore, the generation unit 2080 can generate the augmented video data 30 by combining a portion of the video data 10 other than the editing target and a frame sequence generated by applying the selected editing process to the editing target.

Here, a plurality of editing processes may sometimes be selected for one editing target. In this case, for example, the selection unit 2060 generates the augmented video data 30 obtained by applying the selected editing processes to the editing target, for each of the selected editing processes.

For example, it is supposed that two editing processes of editing processes E1 and E2 are selected for an editing target T1. In this case, the selection unit 2060 generates each of the augmented video data 30 in which the editing target T1 has been subjected to the editing process E1 and the augmented video data 30 in which the editing target T1 has been subjected to the editing process E2.

Sometimes there may also be a plurality of editing targets. In this case, for example, the selection unit 2060 generates the augmented video data 30 in which each editing target has been subjected to its selected editing process. For example, it is supposed that there are two editing targets of editing targets T1 and T2. It is also supposed that the editing process E1 is selected for the editing target T1 and the editing process E2 is selected for the editing target T2. In this case, the selection unit 2060 generates, as the augmented video data 30, video data in which the editing target T1 has been subjected to the editing process E1 and the editing target T2 has been subjected to the editing process E2.

In such a case where there is a plurality of editing targets, there is a possibility that a plurality of editing processes is selected for each editing target. In this case, for example, the selection unit 2060 generates the augmented video data 30 for each of any combinations of the editing targets and the editing processes.

For example, it is supposed that the editing processes E1 and E2 are selected for the editing target T1 and the editing processes E3 and E4 are selected for the editing target T2. In this case, four patterns of combinations of {(T1, E1), (T2, E3)}, {(T1, E1), (T2, E4)}, {(T1, E2), (T2, E3)}, and {(T1, E2), (T2, E4)} are conceivable as combinations of the editing targets and the editing processes. Here, {(T1, E1), (T2, E3)} represents that the editing target T1 is subjected to the editing process E1 and the editing target T2 is subjected to the editing process E3. Accordingly, in the example, the selection unit 2060 generates the augmented video data 30 for each of the above-described four patterns.

As described above, the augmented video data 30 may be generated without subjecting the editing target to any editing process.

### Generation of Class Information

The generation unit 2080 generates the class information on the augmented video data 30 from the class information on the video data 10, based on the processing process performed by the processing process unit 2040 and the content of the editing process performed on the editing target. For example, the generation unit 2080 deletes the frame sequence 20 deleted by the processing process unit 2040 also from the class information. The generation unit 2080 changes the position of the frame sequence 20 whose position has been changed by the processing process unit 2040, also in the class information.

Furthermore, the generation unit 2080 allocates a class to each video frame included in the editing target, based on the content of the editing process applied to that editing target. For example, the generation unit 2080 divides the editing target into two (for example, divides the editing target into equal portions) to allocate the class of the first target frame sequence 40 to each video frame included in the first half portion of the editing target and allocate the class of the second target frame sequence 50 to each video frame included in the second half portion of the editing target.

In another example, in a case where the editing process is the blending process, classes to be allocated to the class of each video frame may be determined based on the blending ratio of each video frame. Specifically, the generation unit 2080 allocates the class of the video frame 12 used at a higher proportion to the video frame generated by the blending process.

For example, it is supposed that the class of the first target frame sequence is C1 and the class of the second target frame sequence is C2. Then, it is supposed that a certain video frame included in the editing target is generated by blending the video frame 12 as the first target frame sequence and the video frame 12 as the second target frame sequence at a blending ratio of a:b. In this case, the generation unit 2080 allocates the class C1 to the certain video frame in a case where a>=b holds and allocates the class C2 to the certain video frame in a case where a<b holds.

### Output of Result

The data augmentation device 2000 outputs an execution result. Hereinafter, information output from the data augmentation device 2000 will be denoted as output information. The output information includes the augmented video data 30. In a case where the augmented video data 30 and the class information relating to the augmented video data 30 are configured separately, the output information further includes the class information on the augmented video data 30. Here, in a case where a plurality of pieces of augmented video data 30 is generated, the output information includes a plurality of combinations of the augmented video data 30 and the class information.

The output information may indicate the content of the processing process or the editing process performed when the augmented video data 30 is generated, in association with that augmented video data 30.

The output information may be output in any form. For example, the data augmentation device 2000 stores the output information in any storage device. In another example, the data augmentation device 2000 may transmit the output information to any device. For example, a transmission destination device is a device that trains an identifier that identifies a class of each video frame included in the frame sequence using the augmented video data 30.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

In the above-described examples, the program includes a group of instructions (or software code) for causing a computer to perform one or more functions described in the example embodiments when being read by the computer. The program may be stored in a non-transitory computer-readable medium or a tangible storage medium. By way of example and not by way of limitation, a computer-readable medium or tangible storage medium includes a random-access memory (RAM), a read-only memory (ROM), a flash memory, a solid-state drive (SSD), or other memory technologies, a compact disc read-only memory (CD-ROM), a digital versatile disc (DVD), a Blu-ray (registered trademark) disc, or other optical disc storages, a magnetic cassette, a magnetic tape, a magnetic disk storage, or other magnetic storage devices. The program may be transmitted through a transitory computer-readable medium or a communication medium. By way of example and not by way of limitation, a transitory computer-readable medium or a communication medium includes electrical, optical, acoustic, or other forms of propagated signals.

Some or all of the above-described example embodiments may be described as the following Supplementary Notes, but are not limited to the following.

### Supplementary Note 1

A data augmentation device comprising:
an acquisition means for acquiring video data including a plurality of frame sequences each of which includes a plurality of consecutive video frames belonging to a same class, the frame sequences adjacent to each other belonging to different classes from each other;
a processing process means for executing a deleting process of deleting one or more of the frame sequences, a position changing process of changing a position of one or more of the frame sequences, or both of the deleting process and the position changing process on the video data;

a selection means for selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and
a generation means for generating augmented video data by applying the selected editing process to the video data.

### Supplementary Note 2

The data augmentation device according to claim 1,
wherein the selection means performs:
calculating an appropriacy score representing a degree of appropriateness of each of the plurality of editing processes, for each of the editing processes, based on results of executing the editing processes on the editing target; and
selecting the editing process to be executed on the editing target, based on the appropriacy score.

### Supplementary Note 3

The data augmentation device according to claim 2,
wherein the selection means performs:
calculating a first motion feature value representing a feature of a motion of an object represented by the first target frame sequence and the second target frame sequence;
calculating a second motion feature value representing a feature of the motion of the object represented by the editing target; and
calculating a degree of similarity between the first motion feature value and the second motion feature value as the appropriacy score.

### Supplementary Note 4

The data augmentation device according to claim 3,
wherein the first motion feature value represents a statistical value of magnitude of the motion of the object calculated for the first target frame sequence and the second target frame sequence,
wherein the second motion feature value represents a statistical value of magnitude of the motion of the object calculated for the editing target, and
wherein the appropriacy score represents a ratio between the first motion feature value and the second motion feature value.

### Supplementary Note 5

The data augmentation device according to claim 3,
wherein the first motion feature value represents a distribution of magnitude of the motion of the object calculated for the first target frame sequence and the second target frame sequence,
wherein the second motion feature value represents a distribution of magnitude of the object calculated for the editing target, and
wherein the appropriacy score represents a degree of similarity between the distribution represented by the first motion feature value and the distribution represented by the second motion feature value.

### Supplementary Note 6

The data augmentation device according to any one of claims 1 to 5, wherein the plurality of editing processes includes a blending process of blending an end portion of the first target frame sequence with a start portion of the second target frame sequence, an interpolation process of inserting one or more video frames between the first target frame sequence and the second target frame sequence, or both of the blending process and the interpolation process.

### Supplementary Note 7

The data augmentation device according to claim 6, wherein the plurality of editing processes includes a plurality of blending processes of blending an end portion of the first target frame sequence and a start portion of the second target frame sequence at different ratios from each other, a plurality of blending processes in each of which a length of a blending section between an end portion of the first target frame sequence and a start portion of the second target frame sequence is different, or a plurality of interpolation processes in each of which generation algorithms for the one or more video frames to be inserted is different.

### Supplementary Note 8

A data augmentation method executed by a computer, the data augmentation method comprising:
an acquisition step of acquiring video data including a plurality of frame sequences each of which includes a plurality of consecutive video frames belonging to a same class, the frame sequences adjacent to each other belonging to different classes from each other;
a processing process step of executing a deleting process of deleting one or more of the frame sequences, a position changing process of changing a position of one or more of the frame sequences, or both of the deleting process and the position changing process on the video data;
a selection step of selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and
a generation step of generating augmented video data by applying the selected editing process to the video data.

### Supplementary Note 9

The data augmentation method according to claim 8,
wherein the selection step includes:
calculating an appropriacy score representing a degree of appropriateness of each of the plurality of editing processes, for each of the editing processes, based on results of executing the editing processes on the editing target; and
selecting the editing process to be executed on the editing target, based on the appropriacy score.

### Supplementary Note 10

The data augmentation method according to claim 9,
wherein the selection step includes:
calculating a first motion feature value representing a feature of a motion of an object represented by the first target frame sequence and the second target frame sequence;
calculating a second motion feature value representing a feature of the motion of the object represented by the editing target; and
calculating a degree of similarity between the first motion feature value and the second motion feature value as the appropriacy score.

### Supplementary Note 11

The data augmentation method according to claim 10,
wherein the first motion feature value represents a statistical value of magnitude of the motion of the object calculated for the first target frame sequence and the second target frame sequence,
wherein the second motion feature value represents a statistical value of magnitude of the motion of the object calculated for the editing target, and
wherein the appropriacy score represents a ratio between the first motion feature value and the second motion feature value.

### Supplementary Note 12

The data augmentation method according to claim 10,
wherein the first motion feature value represents a distribution of magnitude of the motion of the object calculated for the first target frame sequence and the second target frame sequence,
wherein the second motion feature value represents a distribution of magnitude of the object calculated for the editing target, and
wherein the appropriacy score represents a degree of similarity between the distribution represented by the first motion feature value and the distribution represented by the second motion feature value.

### Supplementary Note 13

The data augmentation method according to any one of claims 8 to 12, wherein the plurality of editing processes includes a blending process of blending an end portion of the first target frame sequence with a start portion of the second target frame sequence, an interpolation process of inserting one or more video frames between the first target frame sequence and the second target frame sequence, or both of the blending process and the interpolation process.

### Supplementary Note 14

The data augmentation method according to claim 13, wherein the plurality of editing processes includes a plurality of blending processes of blending an end portion of the first target frame sequence and a start portion of the second target frame sequence at different ratios from each other, a plurality of blending processes in each of which a length of a blending section between an end portion of the first target frame sequence and a start portion of the second target frame sequence is different, or a plurality of interpolation processes in each of which generation algorithms for the one or more video frames to be inserted is different.

### Supplementary Note 15

A program for causing a computer to execute:
an acquisition step of acquiring video data including a plurality of frame sequences each of which includes a plurality of consecutive video frames belonging to a same class, the frame sequences adjacent to each other belonging to different classes from each other;
a processing process step of executing a deleting process of deleting one or more of the frame sequences, a position changing process of changing a position of one or more of the frame sequences, or both of the deleting process and the position changing process on the video data;
a selection step of selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and
a generation step of generating augmented video data by applying the selected editing process to the video data.

### Supplementary Note 16

The program according to claim 15,
wherein the selection step includes:
calculating an appropriacy score representing a degree of appropriateness of each of the plurality of editing processes, for each of the editing processes, based on results of executing the editing processes on the editing target; and
selecting the editing process to be executed on the editing target, based on the appropriacy score.

### Supplementary Note 17

The program according to claim 16,
wherein the selection step includes:
calculating a first motion feature value representing a feature of a motion of an object represented by the first target frame sequence and the second target frame sequence;
calculating a second motion feature value representing a feature of the motion of the object represented by the editing target; and
calculating a degree of similarity between the first motion feature value and the second motion feature value as the appropriacy score.

### Supplementary Note 18

The program according to claim 17,
wherein the first motion feature value represents a statistical value of magnitude of the motion of the object calculated for the first target frame sequence and the second target frame sequence,
wherein the second motion feature value represents a statistical value of magnitude of the motion of the object calculated for the editing target, and
wherein the appropriacy score represents a ratio between the first motion feature value and the second motion feature value.

### Supplementary Note 19

The program according to claim 17,
wherein the first motion feature value represents a distribution of magnitude of the motion of the object calculated for the first target frame sequence and the second target frame sequence,
wherein the second motion feature value represents a distribution of magnitude of the object calculated for the editing target, and
wherein the appropriacy score represents a degree of similarity between the distribution represented by the first motion feature value and the distribution represented by the second motion feature value.

### Supplementary Note 20

The program according to any one of claims 15 to 19, wherein the plurality of editing processes includes a blending process of blending an end portion of the first target frame sequence with a start portion of the second target frame sequence, an interpolation process of inserting one or more video frames between the first target frame sequence and the second target frame sequence, or both of the blending process and the interpolation process.

### Supplementary Note 21

The data augmentation method according to claim 13, wherein the plurality of editing processes includes a plurality of blending processes of blending an end portion of the first target frame sequence and a start portion of the second target frame sequence at different ratios from each other, a plurality of blending processes in each of which a length of a blending section between an end portion of the first target frame sequence and a start portion of the second target frame sequence is different, or a plurality of interpolation processes in each of which generation algorithms for the one or more video frames to be inserted is different.

This application is based upon and claims the benefit of priority from Japanese patent application No. 2023-024891, filed on Feb. 21, 2023, the disclosure of which is incorporated herein in its entirety by reference.

### REFERENCE SIGNS LIST

10 video data
12 video frame
20 frame sequence
30 augmented video data
40 first target frame sequence
42 frame sequence
50 second target frame sequence
52 frame sequence
60 frame sequence
200 table
202 frame identification information
204 class identification information
300 table
302 start frame identification information
304 end frame identification information
306 class identification information
1000 computer
1020 bus
1040 processor
1060 memory
1080 storage device
1100 input/output interface
1120 network interface
2000 data augmentation device
2040 processing process unit
2060 selection unit
2080 generation unit

What is claimed is:

1. A data augmentation device comprising:
at least one memory that is configured to store instructions; and
at least one processor that is configured to execute the instructions to:
acquire video data including a plurality of frame sequences each of which includes a plurality of consecutive video frames belonging to a same class, the frame sequences adjacent to each other belonging to different classes from each other;
execute a deleting process of deleting one or more of the frame sequences, a position changing process of changing a position of one or more of the frame sequences, or both of the deleting process and the position changing process on the video data;
select, from among a plurality of editing processes, an editing process to be executed on an editing target that is a connection portion between a first target frame sequence and a second target frame sequence that have become adjacent due to the deleting process or the position changing process, or that is a portion before or after the connection portion; and
generate augmented video data by applying the selected editing process to the video data.

2. The data augmentation device according to claim 1,
wherein the selection of the editing process includes:
calculating an appropriacy score representing a degree of appropriateness of each of the plurality of editing processes, for each of the editing processes, based on results of executing the editing processes on the editing target; and
selecting the editing process to be executed on the editing target, based on the appropriacy score.

3. The data augmentation device according to claim 2,
wherein the selection of the editing process includes:
calculating a first motion feature value representing a feature of a motion of an object represented by the first target frame sequence and the second target frame sequence;
calculating a second motion feature value representing a feature of the motion of the object represented by the editing target; and
calculating a degree of similarity between the first motion feature value and the second motion feature value as the appropriacy score.

4. The data augmentation device according to claim 3,
wherein the first motion feature value represents a statistical value of magnitude of the motion of the object calculated for the first target frame sequence and the second target frame sequence,
wherein the second motion feature value represents a statistical value of magnitude of the motion of the object calculated for the editing target, and
wherein the appropriacy score represents a ratio between the first motion feature value and the second motion feature value.

5. The data augmentation device according to claim 3,
wherein the first motion feature value represents a distribution of magnitude of the motion of the object calculated for the first target frame sequence and the second target frame sequence,
wherein the second motion feature value represents a distribution of magnitude of the motion of the object calculated for the editing target, and
wherein the appropriacy score represents a degree of similarity between the distribution represented by the first motion feature value and the distribution represented by the second motion feature value.

6. The data augmentation device according to claim 1, wherein the plurality of editing processes includes a blending process of blending an end portion of the first target frame sequence with a start portion of the second target frame sequence, an interpolation process of inserting one or more video frames between the first target frame sequence and the second target frame sequence, or both of the blending process and the interpolation process.

7. The data augmentation device according to claim 6, wherein the plurality of editing processes includes a plurality of blending processes of blending an end portion of the first target frame sequence and a start portion of the second target frame sequence at different ratios from each other, a plurality of blending processes in each of which a length of a blending section between an end portion of the first target frame sequence and a start portion of the second target frame sequence is different, or a plurality of interpolation processes in each of which generation algorithms for the one or more video frames to be inserted is different.

8. A data augmentation method executed by a computer, the data augmentation method comprising:
acquiring video data including a plurality of frame sequences each of which includes a plurality of consecutive video frames belonging to a same class, the frame sequences adjacent to each other belonging to different classes from each other;
executing a deleting process of deleting one or more of the frame sequences, a position changing process of changing a position of one or more of the frame sequences, or both of the deleting process and the position changing process on the video data;
selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and
generating augmented video data by applying the selected editing process to the video data.

9. The data augmentation method according to claim 8,
wherein the selection of the editing process includes:
calculating an appropriacy score representing a degree of appropriateness of each of the plurality of editing processes, for each of the editing processes, based on results of executing the editing processes on the editing target; and
selecting the editing process to be executed on the editing target, based on the appropriacy score.

10. The data augmentation method according to claim 9,
wherein the selection of the editing process includes:
calculating a first motion feature value representing a feature of a motion of an object represented by the first target frame sequence and the second target frame sequence;
calculating a second motion feature value representing a feature of the motion of the object represented by the editing target; and
calculating a degree of similarity between the first motion feature value and the second motion feature value as the appropriacy score.

11. The data augmentation method according to claim 10,
wherein the first motion feature value represents a statistical value of magnitude of the motion of the object calculated for the first target frame sequence and the second target frame sequence,
wherein the second motion feature value represents a statistical value of magnitude of the motion of the object calculated for the editing target, and
wherein the appropriacy score represents a ratio between the first motion feature value and the second motion feature value.

12. The data augmentation method according to claim 10,
wherein the first motion feature value represents a distribution of magnitude of the motion of the object calculated for the first target frame sequence and the second target frame sequence,
wherein the second motion feature value represents a distribution of magnitude of the motion of the object calculated for the editing target, and
wherein the appropriacy score represents a degree of similarity between the distribution represented by the first motion feature value and the distribution represented by the second motion feature value.

13. The data augmentation method according to claim 8, wherein the plurality of editing processes includes a blending process of blending an end portion of the first target frame sequence with a start portion of the second target frame sequence, an interpolation process of inserting one or more video frames between the first target frame sequence and the second target frame sequence, or both of the blending process and the interpolation process.

14. The data augmentation method according to claim 13, wherein the plurality of editing processes includes a plurality of blending processes of blending an end portion of the first target frame sequence and a start portion of the second target frame sequence at different ratios from each other, a plurality of blending processes in each of which a length of a blending section between an end portion of the first target frame sequence and a start portion of the second target frame sequence is different, or a plurality of interpolation processes in each of which generation algorithms for the one or more video frames to be inserted is different.

15. A non-transitory computer-readable medium storing a program for causing a computer to execute:
acquiring video data including a plurality of frame sequences each of which includes a plurality of consecutive video frames belonging to a same class, the frame sequences adjacent to each other belonging to different classes from each other;
executing a deleting process of deleting one or more of the frame sequences, a position changing process of changing a position of one or more of the frame sequences, or both of the deleting process and the position changing process on the video data;
a selection step of selecting, from among a plurality of editing processes, an editing process to be executed on an editing target that is a connection portion between a first target frame sequence and a second target frame sequence that have become adjacent due to the deleting process or the position changing process, or that is a portion before or after the connection portion; and
generating augmented video data by applying the selected editing process to the video data.

16. The medium according to claim 15,
wherein the selection of the editing process includes:
calculating an appropriacy score representing a degree of appropriateness of each of the plurality of editing processes, for each of the editing processes, based on results of executing the editing processes on the editing target; and
selecting the editing process to be executed on the editing target, based on the appropriacy score.

17. The medium according to claim 16,
wherein the selection of the editing process includes:
calculating a first motion feature value representing a feature of a motion of an object represented by the first target frame sequence and the second target frame sequence;
calculating a second motion feature value representing a feature of the motion of the object represented by the editing target; and
calculating a degree of similarity between the first motion feature value and the second motion feature value as the appropriacy score.

18. The medium according to claim 17,
wherein the first motion feature value represents a statistical value of magnitude of the motion of the object calculated for the first target frame sequence and the second target frame sequence,
wherein the second motion feature value represents a statistical value of magnitude of the motion of the object calculated for the editing target, and
wherein the appropriacy score represents a ratio between the first motion feature value and the second motion feature value.

19. The medium according to claim 17,
wherein the first motion feature value represents a distribution of magnitude of the motion of the object calculated for the first target frame sequence and the second target frame sequence,
wherein the second motion feature value represents a distribution of magnitude of the motion of the object calculated for the editing target, and
wherein the appropriacy score represents a degree of similarity between the distribution represented by the first motion feature value and the distribution represented by the second motion feature value.

20. The medium according to claim 15, wherein the plurality of editing processes includes a blending process of blending an end portion of the first target frame sequence with a start portion of the second target frame sequence, an interpolation process of inserting one or more video frames between the first target frame sequence and the second target frame sequence, or both of the blending process and the interpolation process.
